(19) United States
(12) Patent Application Publication
(10) Pub. No.: US 2025/0357546 A1
(43) Pub. Date: Nov. 20, 2025

(54) STERILIZABLE LITHIUM ION BATTERIES

(71) Applicants: Wildcat Discovery Technologies, Inc., San Diego, CA (US); Medtronic, Inc., Minneapolis, MN (US)

(72) Inventors: Hui Wang, San Diego, CA (US); Gang Cheng, San Diego, CA (US); Laura Mccalla, Brossard (CA); Prabhakar A. Tamirisa, Brooklyn Park, MN (US); Lu Yu, Shakopee, MN (US); Eric Hanson, Maple Grove, MN (US)

(21) Appl. No.: 19/130,477

(22) PCT Filed: Nov. 14, 2023
(86) PCT No.: PCT/US2023/037251

§ 371 Date: May 15, 2025

Related U.S. Application Data
(60) Provisional application No. 63/427,190, filed on Nov. 22, 2022.

(51) Int. Cl. H01M 10/0569; H01M 4/525; H01M 4/587; H01M 10/0525; H01M 10/0567; H01M 10/42; H01M 50/489

(52) U.S. Cl. CPC H01M 10/0569; H01M 4/525; H01M 4/587; H01M 10/0525; H01M 10/0567; H01M 10/4235; H01M 50/489; H01M 2300/0034; H01M 2300/004

(57) ABSTRACT

A battery that may be exposed to high temperatures such as when steam sterilizing that retains its capacity may be comprised a cathode comprised of lithium metal oxide, an anode comprised of graphitic carbon, a separator comprising a material having a melt temperature of at least 140° C. and an electrolyte comprising a low boiling point solvent, a high boiling point solvent and a salt, wherein the battery may contain two or more high boiling point solvents or the salt be comprised of lithium difluoro(oxalate)borate.

### FIELD

The disclosure is directed to lithium ion batteries and in particular to lithium ion batteries that may be subjected to elevated temperatures.

### BACKGROUND

Battery powered medical devices are desirable, but may require sterilization. Lithium ion batteries are highly useful for such devices because of their energy density and ability to deliver sufficient power. However, for these devices to be useful they must be sterilized, which typically requires the use of a steam autoclave (e.g., 134° C. for 18 minutes). Other methods such as the use of hydrogen peroxide vapor are available, but require specialized equipment not commonly available to many hospitals.

Common commercially available lithium ion batteries typically operate in a narrow temperature range (e.g., −20° C. to 60° C.) and use components that evaporate, degrade, or decompose under autoclavable conditions. For example, typical separators comprised of polyethylene deform or melt at the autoclavable temperature. Likewise, common solvents of the liquid electrolytes such as linear carbonates have boiling points less than 140° C. There are some specialty batteries that are designed to operate at extremely high temperatures, including up to 180° C. for deep drilling applications (see, e.g., U.S. Pat. Pub. No. US 2006/0019164 (Bonhommet et al.)). This particular battery exclusively uses high boiling point (bp) solvents (bp greater than ˜140° C.) such as ethylene carbonate (EC) and propylene carbonate (PC). At application temperature, however, these cyclic carbonate solvents have very high viscosities and thus low ionic conductivities, resulting in poor power performance at ambient operating temperatures.

Accordingly, it would be desirable to provide a battery that improves or addresses one or more of the problems of lithium batteries for use in medical applications such as those requiring sterilization by steam autoclaving. In particular, it would be desirable to provide a lithium ion battery that is autoclavable having good capacity retention and power delivery at ambient conditions.

### SUMMARY

Applicant has discovered lithium ion batteries that may be sterilized at high temperatures such as those experienced in steam autoclaves when using lithium metal oxides (e.g., lithium metal oxides having a layer structure such as cobalt oxide) used with graphitic anodes and particular electrolytes and high temperature separators.

In an illustration a battery is comprised of a cathode comprised of lithium metal oxide, an anode, a separator comprising a material having a melt temperature of at least 150° C. and an electrolyte comprising a low boiling point solvent, a high boiling point solvent and a salt, and the salt is comprised of lithium difluoro(oxalate)borate (LiDFOB) and the LiDFOB, by mole, is a majority (i.e., greater than 50% by mole) of the salt present in the electrolyte.

In another illustration a battery is comprised of a cathode comprised of lithium metal oxide, an anode, a separator comprising a material having a melt temperature of at least 140° C. and an electrolyte comprising a low boiling point solvent, a high boiling point solvent and a salt, wherein the high boiling solvent is comprised of at least two high boiling solvents having boiling points that are at least 20° C. different. A high boiling solvent is one having a boiling point of at least 140° C. and a low boiling point solvent is one having a boiling point below 140° C.

### DETAILED DESCRIPTION

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The terms “halo” and “halogen” as used herein refer to an atom selected from fluorine (fluoro, —F), chlorine (chloro, —Cl), bromine (bromo, —Br), and iodine (iodo, —I). The term “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain 1-40 carbon atoms, 1-20 carbon atoms, 2-20 carbon atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Exemplary aliphatic groups include, but are not limited to, linear or branched, alkyl and alkenyl groups, and hybrids thereof such as (cycloalkyl)alkyl, (cycloalkenyl)alkyl or (cycloalkyl)alkenyl. The aliphatic groups may be unsubstituted or substituted. Substituted means that one or more C or H atoms is replaced with oxygen, boron, sulfur, nitrogen, phosphorus or halogen. Typically, one to six carbon atoms may be independently replaced by the aforementioned and in particular oxygen, sulfur or nitrogen. The aliphatic group may have one or more “halo” and “halogen” atoms selected from fluorine (fluoro, —F), chlorine (chloro, —Cl), bromine (bromo, —Br), and iodine (iodo, —I).

If not otherwise specified any characteristic or property may be determined by standard laboratory practices for determining such properties or characteristics. The melt temperature is the onset melt temperature unless explicitly stated otherwise and may be determined as described in ASTM D3418-5. Unless otherwise specified the heating rate used for the DSC in determining the melt temperature is 20° C./minute. The boiling temperature may be determined by ASTM D86 if not generally available in the literature.

The batteries are comprised of a cathode, anode, separator and electrolyte. It is understood that each of these components may be connected or contained with common components of a battery such as current collectors coated with the anode and cathode and battery containers encompassing the battery components with electrical connection to the battery. For example, the current collector may be any suitable metal (e.g., Al, Alloys of Al and Cu and alloys of Cu) foil, sheet or the like such as a metal foil that may be further coated with an electrically conducting material such as carbon including those described by U.S. Pat. No. 9,172,085, incorporated herein by reference.

The cathode of the battery is comprised of any suitable lithium metal oxide capable of intercalating lithium ions such as those known in the art such as described in Development of High Capacity Li-rich Layered Cathode Materials for Lithium Ion Batteries, Delai Ye, The University of Queensland, 2014. Exemplary lithium metal oxides include those comprised of one or more of cobalt, manganese, nickel and vanadium and in particular those oxides having a layered structure.

The cathode may further include other cathode components such as binders and electrically conducting additives. The binder may be any suitable such as those known in the art and may include, for example, carboxy methyl cellulose (CMC), styrene-butadiene rubber (SBR), polyvinylidene fluoride (PVDF), poly-tetrafluoroethylene (PTFE), or a mixture of two or more thereof. Desirably, the cathode is comprised of PVDF. The electrically conducting additive may also be any suitable material such as those known in the art. For example, the electrically conducting material may be a conducting carbon such as graphite, carbon black, carbon nanotubes, graphene and carbon fiber.

The amount of other cathode components may be any suitable amount, but generally is at most about 20% or 10% by volume to about 0.1%, 0.5% or 1% by volume of the cathode (i.e., lithium metal oxide and other cathode components).

The anode is comprised of graphitic carbon. Graphitic carbon may be any carbon capable of intercalating lithium with it being understood that carbons exhibiting short range order, but limited long range order that appear amorphous by X-ray diffraction may be used. The graphitic carbon, illustratively may be synthetic or natural graphite having sufficient purity for use in lithium ion batteries, which typically requires a purity of at least about 99.5%, 99.9 or 99.95%. Illustratively, the graphitic carbon may be a spherical graphite, with it being understood that such graphite is not perfectly spherical but may be ovoid in nature, but are not flakes. The spherical graphite, generally, has a high purity such as at least 99.95% pure, but may also be comprised of a small amount of oxides such as silica, titania and zirconia or other materials capable of intercalating lithium but these are present in an amount of less than 5% or 1% by volume of the cathode. The anode may also be comprised of other additives such as described for the cathode herein (e.g., binders and electrically conductive additives). The spherical graphite may be from artificial graphite or purified natural graphite. Examples of useful spherical graphites are described in U.S. Pat. Pub. 2016/0141603 and U.S. Pat. No 9,276,257, each incorporated herein by reference.

Examples of suitable commercially available spherical graphites include those available from Syrah Resources, Magnis Resources, Northern Graphite, Focus Graphite and Graphite One.

The separator of the battery may be any that is able to survive steam sterilization conditions and typically has a melt temperature of at least 150° C. The separator may have one or more layers that may be bonded together. Examples of suitable separators includes a poly-imide, polyolefin (such as polypropylene), polyethylene terephthalate, ceramic-coated polyolefin, cellulose, or a mixture of two or more thereof. Such materials may be in the form of microfibers or nanofibers. The separator may include a combination of microfibers and nanofibers. In certain embodiments, the separator includes polyethylene terephthalate microfibers and cellulose nanofibers. Illustrations of separators that may be useful include those described in U.S. Pat. No. 8,936,878, incorporated herein by reference. Further examples of separators include those available from Dreamweaver International (Greer S.C). Typically, the separator is at most 250 micrometers thick to at least about 5 or 10 micrometers thick.

A separator having multiple layers may be used, each of which has a melting point greater than 150° C. However, one of these layers may have a melting point lower than the other layer and may serve the purpose of a shutdown separator. For example, an inner layer of a separator may have a melting point of approximately 130° C. and a layer that may have a melting point of approximately 160° C. In this illustration, the inner layer would melt at a temperature about 130° C., preventing ion flow in the battery but maintaining physical separation between the anode and cathode to prevent shorting. In other illustrations, the inner layer of the separator may have a melting point of about 130° C. or slightly above the temperature reached during steam sterilization and the outer layer may have a melting point of >200° C. An example of a useful material having a melting point of approximately 130° C. is high density polyethylene or ultra-high molecular weight polyethylene. Examples of useful materials that have a melting point of >200° C. include polyimide, polyethylene terephthalate, cellulose, aramid fibers, ceramics, and combinations thereof. In certain embodiments, the multiple separator layers with different melting points may be laminated together to form a single multi-layer composite separator. In certain embodiments, a layer of positive temperature coefficient material may be used.

In an illustration of the battery, the electrolyte comprises a low boiling point solvent and a high boiling point solvent and a salt. The high boiling point solvent is a solvent that has a boiling point of at least 140° C., but desirably is at least 160° C., 180° C. or 200° C. to any practical temperature, but typically at most about 350° C. or 300° C. The low boiling point solvent is a solvent that has a boiling point that is less than 140° C., but typically is at most 130° C., 120° C. or even 100° C. to any practical temperature such as at least 70° C., 90° C. or 100° C. Solvent herein is any low molecular weight (typically at most 300 gram/moles, 250 gram/moles or 200 gram/moles) solvent such as a polar aprotic solvent that is useful in dissolving the salt such as aprotic polar solvents having essentially no water (e.g., less than 100 ppm, 50 ppm or 20 ppm of water by weight).

Generally, the high boiling point solvents are aprotic polar solvents having a high dielectric constant (e.g., dielectric constants greater than 20, 40, 60 or 80). Examples of such solvents include cyclic aprotic polar solvents having one or more substituted atoms such as O, N, S, and halogen (e.g., F). The dielectric constant may be calculated from the dipoles present in the solvent molecule or determined experimentally such as described in J. Phys. Chem. C 2017, 121, 2, 1025-1031.

Generally, the low boiling point solvents are polar aprotic solvents having a low dielectric constant (e.g., at most about 20, 15 or 10). Examples of such solvents include linear or branched aprotic polar solvents having one or more substituted atoms of O, N, S, and halogen (e.g., F). Examples of such solvents include linear carbonates (e.g., ethyl methyl carbonate (EMC), dimethyl carbonate (DMC), diethyl carbonate (DEC)), as well as certain ethers (such as 1,2-diethoxyethane (DME)), linear carboxylic esters (e.g., methyl formate, methyl acetate, ethyl acetate, methyl propionate), and nitriles (e.g., acetonitrile).

The amount of high boiling point solvent and low boiling point solvent present in the electrolyte may be any useful amount that is useful to realize the battery capacity retention desired when exposed to high temperatures. Illustratively, the amount of low boiling solvent/high boiling solvent ratio by weight (solvent ratio) may be 0.1, 0.2, 0.5, 1, 1.2, or 1.5 to 20, 15, 10, 5 or 2.

It has been surprisingly found that substantial increases in capacity retention after high temperature exposure (130° C. to 150° C.) may be achieved when using two or more high boiling point solvents in the electrolyte even when the salt composition is the same or essentially the same as well as the other battery components. Illustratively, the use of two or more high boiling point solvents with boiling points that are at least 10° C., 20° C. or 30° C. different may realize increased capacity after exposure to high temperatures such as experienced in steam sterilization as described in U.S. Pat. No. 11,005,128, from col. 4, line 60 to col. 5, line 47, incorporated herein by reference. Examples of combinations of such high boiling point solvents include one or more of ethylene carbonate (EC), propylene carbonate, (PC), butylene carbonate (BC) and difluorethylene carbonate (DFEC) in combination with one or more of tetramethlyene sulfone (TMS), and fluoroethylene carbonate (FEC).

When two or more high boiling point solvents are present in the electrolyte each may be present in any useful amount. Generally, each high boiling solvent is present in an amount of at least about 10% to 90% by mole of the high boiling point solvents present in the electrolyte. As an illustration, when two high boiling point solvents are present, one such solvent is present from 10%, 20%, 30%, 40% or 50% by mole with the balance being the other high boiling solvent. Desirably, the higher boiling point solvent is from 30% or 50% to 70% by mole of two high boiling point solvents when present. When three high boiling solvents are present, it is desirable that the solvent with boiling point between the other two is at least about 33%, 40% or 50% by mole of the high boiling solvents present in the electrolyte.

The salt of the electrolyte may be any that may be dissolved in the high and low boiling point solvents to realize the desired ionic transport within the battery. The salt may be any useful in battery electrolytes and may include known halo salts, but desirably is comprised of lithium salts solely or in combination with other salts. The lithium salts may be any such as those known in the art. Exemplary salts include lithium bis(oxalato)borate (LiBOB), lithium bis(pentafluoroethylsulfonyl)imide (Li-BETI), lithium bis(fluorosulfonyl)imide (LiFSI), lithium difluoro(oxalato)borate (LiDFOB), lithium tetrafluoroborate (LiBF₄), lithium trifluoromethanesulfonate (LiTriflate), lithium hexafluoroarsenate (LiAsF₆), lithium bis(trifluoromethanesulfonimide) (LiTFSI), and lithium hexafluoro-phosphate (LiPF₆). Desirably, the salt may be comprised of LiTFSI, LiDBOB or combination thereof particularly when two high boiling point solvents are present as described above, with LiDBOB in the absence of LiTFSI being more desirable. When LiDBOB, LiTFSI or combination thereof are present it may be desirable that they are individually or in combination are present in an amount of at least 40%, 50%, 60% or 70% by mole of the salt present in the electrolyte in combination with at least one other salt such as one of those described above. The total amount of the salt may be any useful amount of salt and generally may be from 0.5 M, 1 M, 1.1 M, 1.2 M, 1.3 M to 5 M or 2 M.

It has been discovered that even though electrolytes that contain LiTFSI may realize desirable results for capacity retention after high temperature exposure, the consistency of such batteries particularly when used with only one high boiling solvent may be lacking. Surprisingly, electrolytes comprised of LiDFOB may realize the desired high temperature capacity retention with much less variability between batteries even with only one high boiling point solvent. In a particular illustration, the salt is comprised of LiDFOB in the absence of LiTFSI and desirably with at least one other lithium salt and in particular a salt lacking a sulfur atom. For example, further salts may be comprised of one or more of a different lithium borate salt (e.g., LiBOB and LiBF₄) and a lithium phosphate salt (e.g., LiPF₆). Desirably, both a lithium borate and lithium phosphate salt are present and are present in an amount, by mole, as described above (e.g., at most about 50%, 40% or 30% by mole of the salt present in the electrolyte). When a lithium borate salt and lithium phosphate salt are present they may be present in any useful molar ratio, but generally, it is desirable that the other lithium borate salt/other lithium phosphate salt molar ratio is at least 1 to 5, 4, 3, 2 or 1.5. Illustrative at a salt concentration of 1.1 M: the other lithium phosphate salt (e.g., LiPF₆) maybe 0.15 to 0.25 M, the other lithium borate salt (e.g., LiBOB) may be 0.2 to 0.25 M and the LiDFOB may be from 0.6 to 0.7 M; at a total salt concentration of 1.2 M, the other lithium phosphate salt (e.g., LiPF₆) maybe 0.10 to 0.19 M, the other lithium borate salt (e.g., LiBOB) may be 0.2 to 0.25 M and the LiDFOB may be 0.76 to 0.9 M; and at a total salt concentration of 1.4 M: the other lithium phosphate salt (e.g., LiPF₆) maybe 0.10 to 0.2 M, the other lithium borate salt (e.g., LiBOB) may be 0.26 to 0.40 M and the LiDFOB may be 0.70 to 0.86 M.

### EXAMPLES

### Cell Preparation and Testing Protocol

LCO (lithium cobalt oxide) cathode was prepared by mixing the active material with binder (PVDF, Solvay 5130) and carbon (Li435, Denka) in NMP and coating on an aluminum current collector. The resulting dried electrode is 92.4 weight % active material, 2.95 weight % binder, and 4.6 weight % carbon. Electrode loadings are in the range of 18.07-20.5 mg/cm² with a calendared density of 3.44 g/cm³.

The graphite (Spherical natural graphite, M11C from Posco) anode was coated on a copper current collector from a slurry containing the active anode material, binder (PVDF, Solvay 5130) and carbon (SuperP, Imerys) in solvent. The resulting dried electrode is 93.9% active material, 5% binder, and 1% carbon, with a total mass loading of 9.22 mg/cm². After calendaring, the anode electrode density is 1.6 g/cm³.

Cells were assembled within an argon filled glove box using a Dreamweaver Titanium 18 separator in an environment with less than 0.1 ppm water. Cells were then electrochemically tested with accompanying heat cycles, as shown below. LCO//graphite voltage limits were chosen as upper cutoff voltage (UCV) 4.2 to lower cutoff voltage (LCV) 3.5V to enable a cathode to anode areal capacity ratio of 1.25, where the cell capacity is limited by the cathode.

The formation and testing protocol of the cells is as follows. After construction, the cells were held at open circuit voltage (OCV) at 25° C. for 12 hours.

### Formation:

Cycle 1 is a C/20 constant current charge to UCV with a subsequent constant voltage hold to C/50, followed by a 20 minute hold at OCV. The cell is then discharged at C/20 to LCV, followed by a 20 minute hold at OCV. Cycle 2 is a C/10 charge to UCV with a constant voltage hold to C/20 and then a 20 minute hold at OCV, followed by discharge at C/10 to LCV and another 20 minute OCV hold. Cycles 3 and 4 are charged to UCV at C/3 with a constant voltage hold to C/20 and a 20 minute OCV hold. Discharge is done at C/3 to LCV and another 20 minute OCV hold.

### Cycle Test:

The cycle test is then done at C/2 charge to UCV with a constant voltage (CV) hold to about C/24 and discharge at C/2 to LCV for about 10 cycles. The CV time is no greater than 3 h.

### Pulse Power Test;

LCO//MCMB: The fully charged cell (4.2 V) is tested by a pulse power test at varying discharge currents for 5 and 10 seconds. The same pulsing test is performed on the cells charged to several lower voltages. The cell is then discharged to LCV at C/2 and then a low rate cycle test is performed at C/10 from UCV to LCV.

### High Temperature Exposure:

The high temperature exposure test is then performed on the cell by the below high temperature exposure protocol.
50% SOC (state of charge) @120° C. 2 h
100% SOC @120° C. 2 h
50% SOC @135° C. 2 h
100% SOC @135° C. 2 h

Over 2.3 hours, the cell is heated from 25° C. to each target high temperature. The target temperature is then held for 2 hours. The cell is then cooled back to 25° C. over a one hour time period, after which it is held at OCV for 4 hours at 25° C.

### Post Exposure Tests:

After each high temperature exposure cycle, the cell is discharged to LCV to obtain the remaining capacity. The pulse power test and cycling test are repeated.

Subsequent high temperature exposures, low rate cycling, and pulse power tests are repeated multiple times and the results after 4 heat exposure cycles are reported compared to the same cells without high temperature exposure.

The electrolyte for each Example and Comparative Example is shown in Table 1 in which the electrolyte solvents are 30% ethylene carbonate (high boiling point solvent) and 70% by weight ethyl methyl carbonate (low boiling point solvent). From the results, replacing LiTFSI salt with LiDFOB improved capacity retention after high temperature exposure as well as realizing greater consistency between cells as shown by the substantially lower standard deviation, while essentially displaying the same average pulse voltage (higher pulse voltage indicates less loss due to increased resistance in the cell).

The electrolyte solvents parts by weight for Comparative Examples 2-4 and Example 4 are shown in Table 2. The salt composition is LiPF₆ (0.05M), LiTFSI (0.9M), and LiBOB (0.15M). As shown in Table 2, the use of a combination of high boiling point solvents having a difference in boiling points of at least 20° C. realizes improved high temperature performance (increased capacity retention) with substantially improved consistency between cells even when using a majority of LiTFSI (0.9M) as the salt, which is unexpected in comparison to Comparative Examples 2 to 4. Similar surprising results are demonstrated with differing salt compositions as shown in Tables 3 and the results of the cells made therefrom in Table 4 after 2 and 3 high temperature cycles. The boiling points, as reported in the literature, for: EC is 247° C., FEC is 212° C. and TMS is 285° C.

TABLE 1

| | | | | | | Discharge | Avg. Pulse |
|---|---|---|---|---|---|---|---|
| | | | | | Remaining | Capacity | Voltage @ |
| | LiTFSI | LiDFOB | LiBOB | LiPF6 | Capacity | Retention | 1 C 20% |
| Ex. | (M) | (M) | (M) | (M) | Retention (%) | (%) | SOC |
| C. 1 | 0.9 | 0 | 0.15 | 0.15 | 51.2 ± 23.7 | 26.8 ± 26.7 | 3 |
| 1 | 0 | 0.7 | 0.25 | 0.15 | 66.8 ± 0 | 60.3 ± 0.5 | 2.9 |
| 2 | 0 | 0.9 | 0.2 | 0.15 | 64.2 ± 1.8 | 61.2 ± 2.7 | 2.9 |
| 3 | 0 | 0.83 | 0.23 | 0.23 | 49.7 ± 2.6 | 43 ± 2.5 | 2.9 |

TABLE 2

| | | | | | | | Average |
|---|---|---|---|---|---|---|---|
| | | | | | Remaining | Discharge | Pulse |
| | | | | | Capacity | Capacity | Voltage @ |
| | EC | FEC | TMS | EMC | Retention | Retention | 1 C 20% |
| Ex | Parts by weight | | | | (%) | (%) | SOC |
| C. 2 | 3 | 0 | 0 | 7 | 51.2 ± 23.7 | 26.8 ± 26.7 | 3 |
| 4 | 1.5 | 1.5 | 0 | 7 | 66.1 ± 2.3 | 41.7 ± 2.2 | 1.9 |
| C. 3 | 0 | 3 | 0 | 7 | 33.8 ± 29.3 | 18.3 ± 17.5 | 1.7 |
| C. 4 | 0 | 0 | 3 | 7 | 20 ± 16.2 | 5.6 ± 11 | 2.1 |

TABLE 3

| Exam- | Solvent (parts by weight) | | | | Salt Concentration (M) | | | |
|---|---|---|---|---|---|---|---|---|
| ples | EC | EMC | FEC | TMS | LiPF6 | LiTFSI | LiBOB | LiDFOB |
| Comp. 5 | 3 | 7 | 0 | 0 | 0.05 | 0.9 | 0.15 | 0 |
| 5 | 3 | 5 | 2 | 0 | 0.2 | 0.7 | 0.2 | 0 |
| 6 | 2 | 7 | 0 | 1 | 0.05 | 0 | 0.2 | 0.85 |

TABLE 4

| | | | Average Pulse | | | Average Pulse |
|---|---|---|---|---|---|---|
| | % Remaining | % Discharge | Voltage @ | % Remaining | % Discharge | Voltage @ |
| | Capacity | Capacity | 1 C 20% | Capacity | Capacity | 1 C 20% |
| | Retention | Retention | SOC | Retention | Retention | SOC |
| Exam- | 2 high | 2 high | 2 high | 3 high | 3 high | 3 high |
| ple | T cycles | T cycles | T cycles | T cycles | T cycles | T cyles |
| Comp. 5 | 56.3 ± 0.9 | 25.2 ± 34.2 | 3 | 12.7 ± 18.9 | 5.1 ± 8.8 | 2.9 |
| 5 | 73.5 ± 0.9 | 65.2 ± 1.7 | 3 | 58.2 ± 2.5 | 40 ± 1.5 | 2.9 |
| 6 | 69.1 ± 0.2 | 61.6 ± 0.3 | 2 | 55.1 ± 1.1 | 47.4 ± 0.6 | 2.9 |

1. A battery comprising a cathode comprised of lithium metal oxide, an anode comprised of graphitic carbon, a separator comprising a material having a melt temperature of at least 140° C. and an electrolyte comprising a low boiling point solvent, a high boiling point solvent and a salt, and the salt is comprised of lithium difluoro(oxalate)borate (LiDFOB) and the LiDFOB, is greater than 50% by mole of the salt present in the electrolyte, wherein the high boiling point solvent is a polar aprotic solvent having a boiling point of at least 160° C. and the low boiling point solvent is a polar aprotic solvent having a boiling point of less than 140° C.

2. The battery of claim 1, wherein the salt is comprised of at least one other salt.

3. The battery of claim 2, wherein the other salt is in the absence of lithium bis(trifluoromethanesulfonimide).

4. (canceled)

5. The battery of 4, wherein the other salt is comprised of lithium bis(oxalate)borate (LiBOB) and lithium hexafluorophosphate (LiPF₆) and the lithium bis(oxalate)borate is present in an amount, by mole, greater than the lithium hexafluorophosphate (LiPF₆) present in the electrolyte.

6. (canceled)

7. (canceled)

8. The battery of claim 2, wherein the salt has a salt concentration of 0.5 molarity to 5 molarity (M).

9. (canceled)

10. The battery of claim 1, wherein the low boiling point solvent is comprised of one or more of a linear carbonate, ether, carboxylic ester, and nitrile.

11. (canceled)

12. (canceled)

13. The battery of claim 10, wherein the low boiling point solvent and high boiling point solvent are present in a solvent ratio of low boiling solvent/high boiling solvent of greater than 1 to 20 by weight.

14. (canceled)

15. The battery of claim 13, wherein the high boiling point solvent is comprised of a cyclic carbonate.

16. (canceled)

17. (canceled)

18. The battery of claim 1, wherein the metal of the lithium metal oxide is comprised of cobalt.

19. (canceled)

20. The battery of claim 18, wherein the graphitic carbon of the anode is comprised of graphite and the graphite comprises a majority of the anode by volume.

21. (canceled)

22. (canceled)

23. (canceled)

24. (canceled)

25. (canceled)

26. (canceled)

27. (canceled)

28. The battery of claim 1, wherein the high boiling point solvent is comprised of at least two high boiling point solvents and the high boiling point solvent has a boiling point of at least 200° C. to 300° C. and the low boiling point solvent has a boiling point of at most 150° C.

29. (canceled)

30. The battery of claim 28, wherein the high boiling point solvent is comprised of two or more high boiling point solvents having boiling points that are at least 20° C. different.

31. (canceled)

32. (canceled)

33. The battery of claim 28, wherein the low boiling point solvent has a boiling point of 80° C. to 120° C.

34. (canceled)

35. A battery comprising a cathode comprised of lithium metal oxide, an anode comprised of graphitic carbon, a separator comprising a material having a melt temperature of at least 140° C. and an electrolyte comprising a low boiling point solvent, a high boiling point solvent and a salt, wherein the high boiling point solvent is comprised of at least two high boiling point solvents having boiling points that are at least 10° C. different, wherein the high boiling point solvent is a polar aprotic solvent having a boiling point of at least 160° C. and the low boiling point solvent is a polar aprotic solvent having a boiling point of less than 140° C.

36. The battery of claim 35, wherein the salt is a lithium salt.

37. The battery of claim 36, wherein the lithium salt is comprised of one or more of lithium difluoro(oxalate)borate and lithium bis (trifluoromethanesulfonimide) in combination with at least one other lithium salt and the lithium difluoro(oxalate)borate and lithium bis (trifluoromethanesulfonimide) are present in the electrolyte in an amount that is at least 50% by mole of the salt present in the electrolyte.

38. (canceled)

39. (canceled)

40. The battery of claim 35, wherein the high boiling point solvent has a boiling point of at least 200° C. to 350° C. and the low boiling point has a boiling point of less than 140° C. and the high boiling point solvents have boiling points that are at least 30° C. different.

41. (canceled)

42. (canceled)

43. The battery of claim 40, wherein the low boiling point solvent has a boiling point of 80° C. to 120° C.

44. (canceled)

45. (canceled)

44. (canceled)

46. (canceled)

47. (canceled)

48. (canceled)

49. (canceled)

50. The battery of claim 35, wherein the low boiling point solvent is comprised of one or more of a linear carbonate, ether, carboxylic ester, and nitrile.

51. A battery of claim 50, wherein the low boiling point solvent is comprised of the linear carbonate and the linear carbonate is comprised of one or more ethyl methyl carbonate (EMC), dimethyl carbonate (DMC), and diethyl carbonate (DEC).

52. (canceled)

53. The battery of claim 35, wherein the low boiling point solvent and high boiling point solvent are present in a solvent ratio of low boiling solvent/high boiling solvent of greater than 0.5 to 10 by weight.

54. (canceled)
